(19) United States
(12) Patent Application Publication
(10) Pub. No.: US 2012/0259971 A1
(43) Pub. Date: Oct. 11, 2012

(54) REAL TIME RELIABILITY CHECK FOR NETWORK LINKS

(75) Inventors: Louie Arthur Dickens, Tucson, AZ (US); Olive Paige Faries, Tucson, AZ (US); Michael Edward Starling, Tucson, AZ (US)

(73) Assignee: INTERNATIONAL BUSINESS MACHINES CORPORATION, Armonk, NY (US)

(21) Appl. No.: 13/081,864

(22) Filed: Apr. 7, 2011

(51) Int. Cl. G06F 15/173

(52) U.S. Cl. 709/224

(57) ABSTRACT

Embodiments of the invention provide a method and corresponding computing device for testing network adapters. The computing device receives a network address for the network. The computing device identifies a device based on the network address, the device having a network adapter. Then the computing device identifies additional devices along a route to the device, each of the additional devices having a respective network adapter. The computing device sends one or more requests to each the network adapters. The computing device determines an indication of reliability of each of the network adapters based on handling of the requests by the network adapter. A network adapter may also maintain logic to test itself in another embodiment.

### BACKGROUND

This disclosure relates generally to communication networks, and more specifically, to searching for network links in real time and testing each link's reliability using test data patterns.

A computer network, or network, is a collection of computers and devices interconnected by communications channels that facilitate communications among users and allow users to share resources. Ethernet and Enhanced Ethernet (the next generation of Ethernet technology) are types of network protocols that utilize various standards and mediums that enable communication between devices. Ethernet is the primary network protocol in data centers for computer to computer communications. A network link is the link or connection of a computer or device to a network. More specifically, a network link may be defined as the network adapter or network interface card, which communicates to other devices and receives communications from the other devices over a network. Network adapters may refer to network interface cards, as well as converged network adapters which contain both a Fibre Channel Host Bus Adapter (HBA) and an Ethernet Network Interface Card (NIC). Network adapters may also be referred to merely as adapters or interface cards and are often Ethernet interface cards. Hereafter, use of “interface card” and “adapter” may be used interchangeably. Frequently deployed network devices include hubs, switches, bridges, and routers.

An Ethernet interface card sends data, as signals, to and receives data from other interface cards in other devices on the network, but does not guarantee that all data sent is received or received in order. In other words, Ethernet is designed to be a best-effort network, with no guarantees of timeliness or even of delivery. Ethernet technology, counts on transport protocols such as TCP/IP (transmission control protocol/internet protocol) to detect errors in transmission and re-drive non-delivered frames. However, as technology improves, especially with the growth of cloud computing and Fibre Channel over the Ethernet, the reliability of the Ethernet must increase and reliance on TCP/IP should be reduced, as the trade-off for using TCP/IP is higher complexity, greater processing overhead and a resulting impact on performance and throughput.

Accurate testing is essential as a first step to increased reliability of the Ethernet. For example, there are known transmission data patterns (a series of signals representing computer readable language) that present interface cards with particular difficulty. Such tests may be referred to as jitter tests. Jitter is the deviation or displacement of some aspect of pulses in a digital signal representative of a bit of sent data. Jitter can lead to a loss of transmitted data between network devices. One parameter measuring jitter, or more specifically, the data lost in part due to jitter, is the bit error rate (BER). BER may be represented as the number of errors over the total number of bits sent.

### SUMMARY

The different embodiments provide a method and corresponding computing device for testing network adapters. The computing device receives a network address for a network. The computing device identifies a device based on the network address, the device having a network adapter. Then the computing device identifies any additional devices along a route to the device, each of the any additional devices having a respective network adapter. The computing device sends one or more requests to the respective network adapter of each of the any additional devices and to the network adapter of the device. The computing device determines an indication of reliability of the respective network adapter of each of the any additional devices based on handling of the one or more requests by the respective network adapter and of the network adapter of the device based on handling of the one or more requests by the network adapter.

In another embodiment, a network adapter is disclosed, the network adapter comprising a chipset responsible for sending and receiving data to and from network devices and control logic for controlling the network adapter. The control logic comprises logic to simulate the receipt of a data stream comprising a data pattern by the network adapter. The control logic further comprises logic to determine whether the network adapter processed the data pattern without any errors. Finally, the control logic comprises logic to log results of the simulation.

### BRIEF DESCRIPTION OF THE SEVERAL VIEWS OF THE DRAWINGS

The following detailed description, given by way of example and not intended to limit the disclosure solely thereto, will best be appreciated in conjunction with the accompanying drawings, in which:

FIG. 1 depicts an illustrative diagram of a data processing environment as a network, specifically an Ethernet local access network (LAN), of data processing systems in which illustrative embodiments may be implemented;

FIG. 2 illustrates a block diagram of internal components of a computing device for testing the reliability of network links in accordance with an illustrative embodiment;

FIG. 3 depicts a flowchart of the steps of reliability testing program 118 for seeking and testing the reliability of network links to devices on the network in accordance with an illustrative embodiment;

FIG. 4 illustrates a flowchart of the steps for path discovery program 120 for discovering each link in the path to a device in accordance with an embodiment of the invention; and

FIG. 5 depicts a flowchart of the steps for verify link program 122 for determining the strength/weakness of a network link in a path to a device in accordance with an illustrative embodiment.

### DETAILED DESCRIPTION

Embodiments of the present invention describe testing of a network link in real-time on an active network, tracking the reliability of the network link over time, and testing all the network links on a network from a single location. These embodiments are described in detail with reference to the figures.

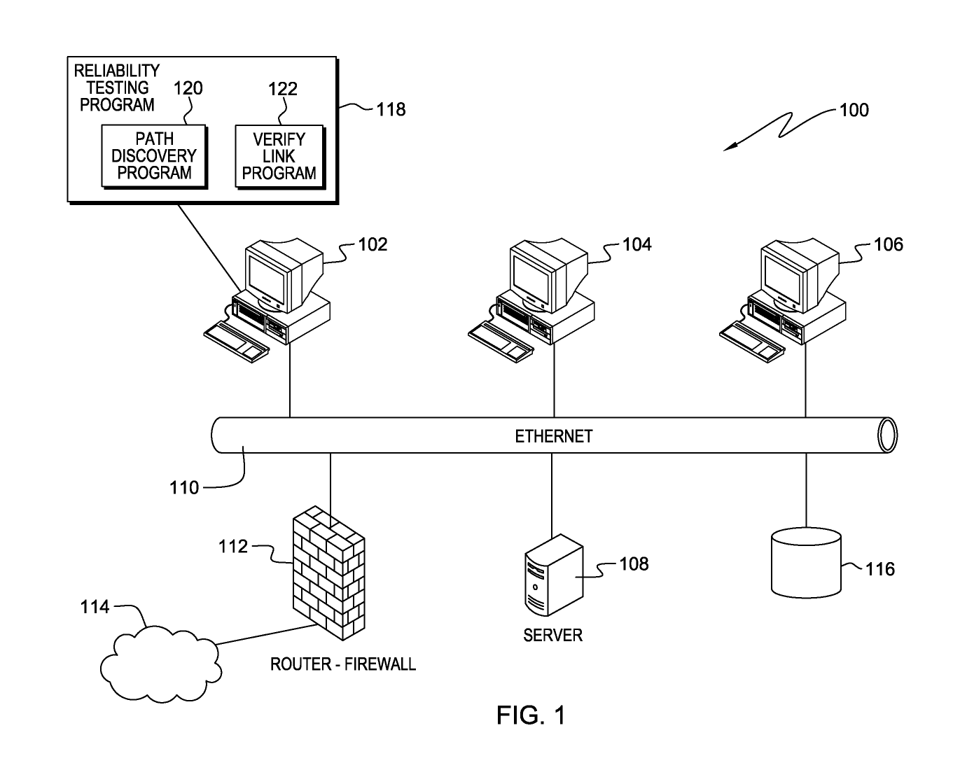

FIG. 1 depicts an illustrative diagram of a data processing environment as a network, specifically an Ethernet local access network (LAN), of data processing systems in which illustrative embodiments may be implemented. It should be appreciated that FIG. 1 provides only an illustration of one implementation and does not imply any limitations with regard to the environments in which different embodiments may be implemented. Many modifications to the depicted environments may be made.

Network data processing system 100 comprises a network of computers (computing devices) in which an embodiment may be implemented. Network data processing system 100 contains Ethernet 110, which acts as a medium for providing communications links between various devices and computers connected together within network data processing system 100. Ethernet 110 may include connections, such as wire, wireless communication links, or fiber optic cables.

In the depicted example, computer 102, computer 104, and computer 106 connect to Ethernet 110 along with server computer 108, router 112, and network storage 116. Router 112 may provide access to a wider network data processing system such as internet 114, which is representative of a worldwide collection of networks and gateways that use the Transmission Control Protocol/Internet Protocol suite of protocols to communicate with one another.

Server 108 may be, for example, a server computer system such as a management server, a web server, or any other electronic device or computing system capable of receiving and sending data. In another embodiment server 108 may represent a server computing system utilizing multiple computers as a server system, such as in a cloud computing environment.

Each of computers 102, 104, and 106 may be, for example, a computing device such as a notebook, a laptop computer, a tablet computer, a handheld device or smart-phone, a thin client, router, hub, or any other electronic device or computing system capable of communicating with another computing device through a network. Network data processing system 100 may include additional server computers, client computers, displays and other devices not shown.

Reliability testing program 118, residing on computer 102, seeks and tests the network links connecting network devices such as computers 104 and 106, server 108, router 112, and network storage 116. In other embodiments, reliability testing program 118 may reside on any computing device, such as computer 104 or 106. The device that reliability testing program 118 resides on may be a stand-alone device devised for the purpose of running reliability testing program 118. Reliability testing program 118 may also seek out other networks and sub-networks and test their corresponding network links. Reliability testing program 118 may run path discovery program 120, for discovering each link in the path to a device on the network, and verify link program 122, for determining the strength/weakness/reliability of a network link to a device.

Data gathered, generated, and maintained for use by reliability testing program 118 may be stored on computer 102 or network storage 116.

In the depicted example, network data processing system 100 is an Ethernet LAN. Network data processing system 100 may also be implemented as a number of different types of networks, such as an intranet or a wide area network (WAN). FIG. 1 is intended as an example and not as an architectural limitation for the different embodiments.

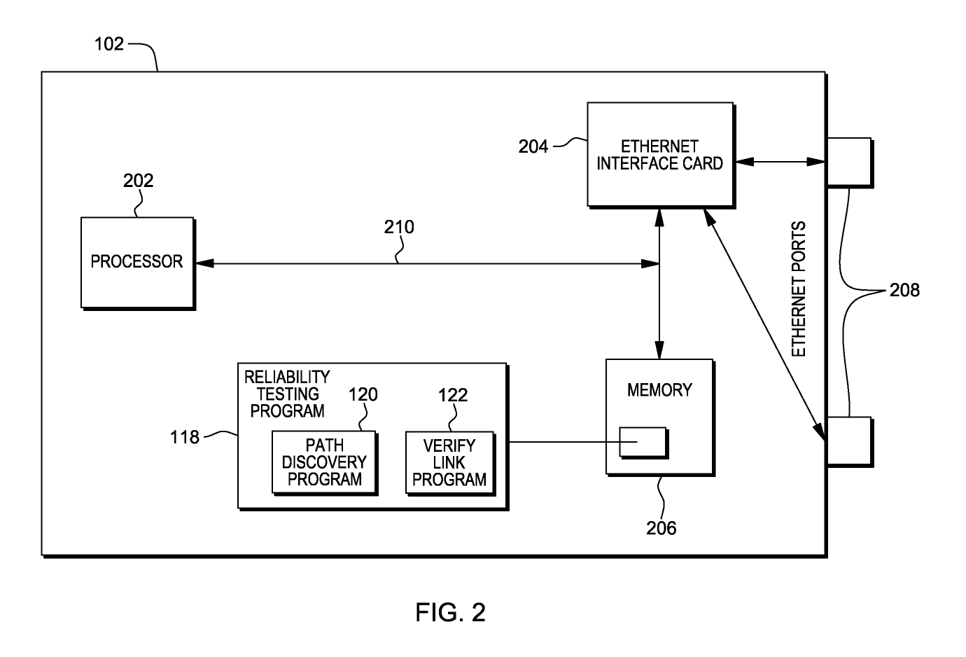

FIG. 2 illustrates a block diagram of internal components of a computing device for testing the reliability of network links in accordance with an illustrative embodiment.

Computer 102 is a computing device or system capable of communicating with other devices on a network and running reliability testing program 118. Computer 102 comprises processor 202, Ethernet interface card 204, memory 206, Ethernet ports 208, and system bus 210. Processor 202, Ethernet interface card 204, and memory 206 communicate via system bus 210.

Ethernet interface card 204, also known as the Ethernet adapter or converged Ethernet adapter, may be composed of various Ethernet chipsets known in the art. The speed of Ethernet interface card 204 is determined by the Ethernet chipsets used. Ethernet interface card 204 may send signals, representative of data, to network devices and receive signals from network devices through Ethernet ports 208.

Memory 206 may be random access memory, hard disk storage such as magnetic disk storage device of an internal hard drive, a semiconductor storage device such as ROM 824, EPROM, or flash memory, optical storage, solid-state memory or any other type of tangible storage device or combination thereof.

Reliability testing program 118, as well as path discovery program 120 and verify link program 122 may be stored in memory 206 for execution by processor 202. Alternatively programs 118, 120, and 122 may be embedded in Ethernet interface card 204 as control logic.

Reliability testing program 118, path discovery program 120, and verify link program 122 can be written in various programming languages (such as Java, C++) including low-level, high-level, object-oriented or non object-oriented languages. Alternatively, the functions of reliability testing program 118, path discovery program 120, and verify link program 122 can be implemented in whole or in part by computer circuits and other hardware (not shown).

In another embodiment, a computing device, such as computer 102 may also include internal components such as a R/W drive or interface to read from and write to one or more portable computer-readable tangible storage devices such as a CD-ROM, DVD, memory stick, magnetic tape, magnetic disk, optical disk or semiconductor storage device. In such an embodiment, reliability testing program 118 may alternatively be stored on one or more of the respective portable computer-readable tangible storage devices, read via the respective R/W drive or interface and loaded into memory 206.

Other embodiments may also include external components such as a computer display monitor, a keyboard, and a computer mouse. Internal components in such embodiments would include device drivers to interface to the computer display monitor, keyboard, and computer mouse.

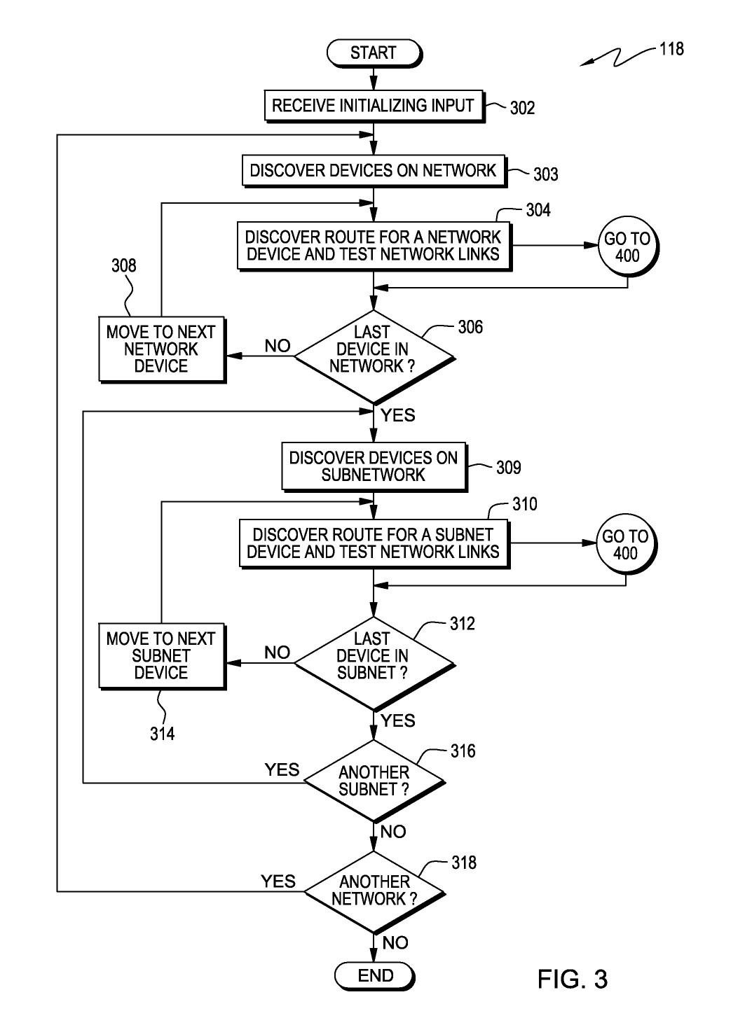

FIG. 3 depicts a flowchart of the steps of reliability testing program 118 for seeking and testing the reliability of network links to devices on the network in accordance with an illustrative embodiment.

In step 302, reliability testing program 118 receives initializing input. Initializing input includes network and sub-network addresses to check the network links on. In one embodiment, the addresses may be supplied by a user. In another embodiment, the addresses may be supplied by a location in memory, such as memory 206. In another embodiment still, the addresses may be supplied by another program. It is also in this step that reliability testing program 118 may set any variables to their starting values.

Reliability testing program 118 goes to a received network address and identifies the devices on the network (step 303). A range of potential device addresses are discernable from a given network address, and numerous methods are known in the art for discovering devices on a network.

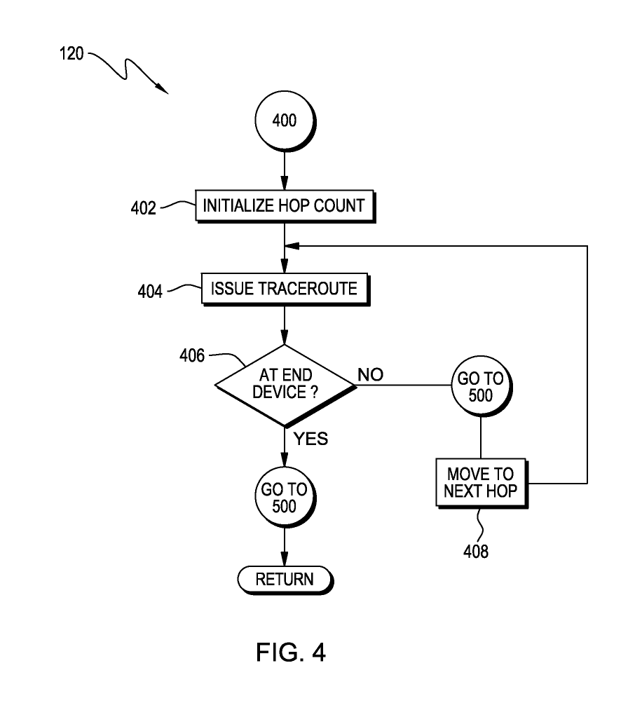

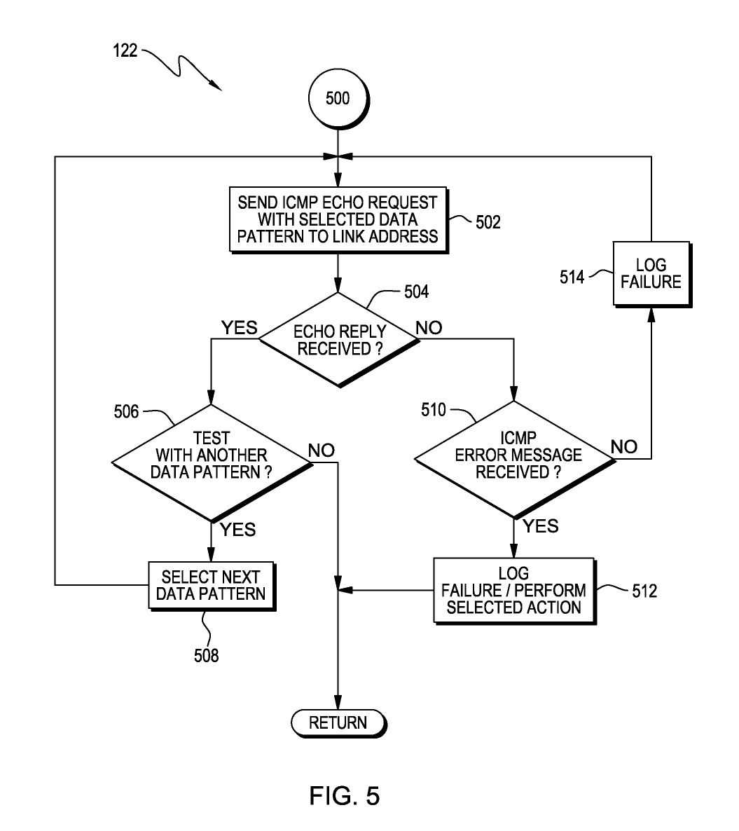

Reliability testing program 118 then discovers a route for a network device and tests the discovered network links on the route (step 304). Reliability testing program 118 may discover the route through path discovery program 120 (starting at reference number 400 depicted in FIG. 4) and may subsequently test each discovered link through verify link program 122 (starting at reference number 500 depicted in FIG. 5).

Reliability testing program 118 determines if the device in the network is the last device in the network (decision block 306). If the device is not the last device in the network, reliability testing program 118 moves to the next network device (step 308) and returns to step 304 to discover the route for the device and complete testing. If the device is the last device in the network, reliability testing program 118 goes to a received sub-network address and identifies devices on the sub-network (step 309). Reliability testing program 118 then discovers a route for a sub-network device and tests the discovered network links (step 310), again using path discovery program 120 and verify link program 122. In another embodiment, the network may be devoid of sub-networks and corresponding devices.

Reliability testing program 118 determines if the device in the sub-network was the last device in the sub-network (decision block 312). If the device was not the last device, reliability testing program 118 moves to the next sub-network device (step 314) and returns to step 310 to discover the route and test the network links.

If the device is the last device in the sub-network, reliability testing program 118 determines if there is another sub-network within the network to search (decision block 316). If there is another sub-network, reliability testing program 118 returns to step 309 to identify devices on the other sub-network. If there is no other sub-network, reliability testing program 118 determines if there is another network (decision block 318). If there is another network, reliability testing program 118 returns to step 303 to identify devices on the other network.

If there is no other network, reliability testing program 118 may end.

In other embodiments, reliability testing program may automatically determine when to run. This determination may be based on user input. In another embodiment, reliability testing program 118 may decide to run if there is low network usage. In another embodiment, reliability testing program 118 decides to run at specified times.

FIG. 4 illustrates a flowchart of the steps for path discovery program 120 for discovering each link in the path to a device in accordance with an embodiment of the invention. Path discovery program 120 works by iteratively searching the path to the end device and by doing so, discovering each link/device along that path for testing. In a preferred embodiment, testing of the link results from and occurs upon the discovery of the link. Within each iteration, path discovery program 120 finds an additional device in the path until the end device is reached.

In one embodiment, path discovery program 120 initializes a hop count (step 402) to keep track of hops to the sought device, hereafter referred to as the end device. A hop count is the number of routers traversed by a packet between the packet's source and the packet's destination, that destination being the end device. A hop count may also include other devices such as repeaters, bridges and gateways. Each of these intermediate devices contains a network adapter and is a link in the network path to the end device. The end device itself contains a network adapter, which may be considered the final link in the path.

Path discovery program 120 issues a traceroute (step 404) for the end device. Traceroute sends a sequence of Internet Control Message Protocol (ICMP) packets addressed to a destination host, in this case, the end device. Path discovery program 120 uses the traceroute to discover links in the path (by keeping track of each hop the ICMP packets traverse) to the end device and ultimately determine if path discovery program 120 has reached the end device (decision block 406). The sent ICMP packets traverse each hop on the way to the end device as long as there is time-to-live (TTL). The TTL is an Internet Protocol parameter that represents a set number of hops the traceroute is allowed to make as it advances towards the end device. If the TTL is exceeded, an ICMP error message, in this case a “time exceeded” error message, is returned to the source. The TTL in this embodiment is the hop count variable, initially one (1). If a “time exceeded” message is received, path discovery program 120 can determine that the device at the corresponding hop is not the end device. If no “time exceeded” message is received, then path discovery program 120 can determine that the end device has been reached.

By following this method, an ICMP error message or an ICMP echo reply may be received by the source. Either type of message contains the address of the link, or more specifically, the interface card, sending it. In another embodiment, if the returned address matches the used end device address, the end device has been reached; otherwise the end device has not been reached.

If it is determined that the end device was not reached, path discovery program 120 goes to reference number 500 (of FIG. 5) where the discovered link (of the intermediary device) may be tested by verify link program 122. Then path discovery program 120 moves to the next hop (step 408). Step 408 may be accomplished by increasing the hop count by one and hence allowing the traceroute to make it one hop farther (and test that the device at that hop) when path discovery program 120 returns to step 404 to issue the traceroute.

If it is determined that the end device was reached, path discovery program 120 goes to reference number 500 (in FIG. 5) where the discovered link (of the end device) is tested by verify link program 122. Path discovery program 120 may then end—returning to reliability testing program 118.

For example, where TTL (as represented by the variable “hop count”) is one, path discovery program 120 issues a traceroute for an end device. The path any ICMP packets must traverse to reach the device may include any number of intermediate devices. The traceroute moves to one hop, i.e., to the first intermediate device. However, because the TTL is set to 1, it can go no further. An ICMP error message is sent that includes the address of the first intermediate device. This link in the path may then be tested. In a second iteration, TTL is increased to 2 and a traceroute is again issued. This time the traceroute will move two hops (i.e., find a second intermediate device) in the path to the end device. This process will continue until the end device is reached. Each link (device) in the path is tested as path discovery program 120 finds it.

FIG. 5 depicts a flowchart of the steps for verify link program 122 for determining the strength/weakness of a network link in a path to a device in accordance with an illustrative embodiment.

Verify link program 122 starts by sending an ICMP echo request with a selected data pattern to the link address (step 502) identified by path discovery program 120 (the address of the interface card). An ICMP echo request, also known as ping, sends an ICMP packet (or packets) with a specified data pattern to a target address, in this case the link address. The source then waits for an ICMP response. Time and packet loss may be recorded.

Specified data patterns that may be sent in an echo request are preferably from a list of worst-case data patterns that are known to give interface cards difficulty. Such patterns may include, for example, a high frequency test pattern (i.e., 1010101010 . . . ), a low frequency test pattern (i.e., 11111000001111100000 . . . ), a mixed frequency test pattern (i.e., 11111010110000010100 . . . ), a continuous random test pattern, and a continuous jitter tolerance test pattern. These patterns are known in the art. User defined testing patterns may also be used.

Verify link program 122 then determines if an echo reply is received (decision block 504). An echo reply is an ICMP message generated in response to an echo request, which includes all the data received from the echo request. Verify link program 122 may make this determination by receiving an echo reply, receiving some other message (such as an error message), or by waiting a specified time for a reply to occur and determining that an echo reply was not received if no message is received within the specified time.

If an echo reply is received, verify link program 122 concludes that the link is good, at least with the selected data pattern, and subsequently determines if there is another data pattern to test the link with (decision block 506).

If verify link program 122 determines that there is another data pattern to test the link with, verify link program 122 selects the next data pattern (step 508) and returns to step 502. If verify link program 122 determines that there is not another data pattern to test with, verify link program 122 returns to path discovery program 120.

If an echo reply is not received, verify link program 122 determines if an ICMP error message is received (decision block 510). If an ICMP error message is received, verify link program 122 logs the link failure and performs a selected action. This action may be an update of link failure statistics, displaying the failure in a user interface or pop up window, displaying failure statistics in a user interface or pop-up window, sending a Twitter® “tweet” of the failure, or any other action that may provide the information to a user. The action may be selected by a user at the time of failure, or in another embodiment may be stored as a preferred action before the running of verify link program 122. Verify link program 122 returns to path discovery program after step 512.

In another embodiment, no action will be performed other than the logging of the failure, and a user may view or manipulate data from a log of the failures.

In another embodiment still, after step 512, verify link program 122 may move to step 506 to test the failed link with other data patterns if they exist.

If an ICMP error message is not received, i.e., a response is not received within a set time, it cannot be determined for sure if the link has an error, and verify link program 122 logs the failure and retries (step 514) returning to step 502. In a preferred embodiment, if the same data pattern is used to test the same link and receives neither an echo reply nor an ICMP error message three times in a row, the failure may be logged and the verify link program 122 returns to path discovery program 120. Threshold limits other than three may be used in other embodiments to ensure that verify link program 122 does not repeat indefinitely.

In another embodiment, verify link program 122 also logs success if an echo reply is received in decision block 504.

In a simplified embodiment, Ethernet interface card 204 may test itself in a real time environment and may keep track of its own failures and successes. In such an embodiment, Ethernet interface card may comprise control logic for implementing a simplified version of verify link program 122. In this embodiment, Ethernet interface card 204 may send itself, or simulate the receipt of, one or more test data patterns to be handled as received data and after Ethernet interface card 204 handles, or processes, the data pattern(s) as received data, Ethernet interface card 204 determines if the data pattern has come through this processing fully intact and any errors that result. Results may be stored and/or displayed on the network device that Ethernet interface card 204 connects to the network. In such an embodiment, Ethernet interface card 204 may run its self-testing program at specified times or when the network is idle. In a preferred embodiment the tests are run intermittently for the life of Ethernet interface card 204 so that a user may keep track of its reliability over time.

Based on the foregoing, a method, computing device, and network interface card have been disclosed for testing network links in an active network or networks. However, numerous modifications and substitutions can be made without deviating from the scope of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. Therefore, the present invention has been disclosed by way of example and not limitation.

What is claimed is:

1. A method for testing network adapters, the method comprising the steps of:
a computing device receiving a network address for a network;
the computing device identifying a device on the network based on the network address, the device having a network adapter;
the computing device identifying any additional devices along a route to the device, each of the any additional devices having a respective network adapter;
the computing device sending one or more requests to the respective network adapter of each of the any additional devices and to the network adapter of the device; and
the computing device determining an indication of reliability for the respective network adapter of each of the any additional devices based on handling of the one or more requests by the respective network adapter and for the network adapter of the device based on handling of the one or more requests by the network adapter.

2. The method of claim 1, wherein the step of identifying any additional devices along the route to the device, occurs sequentially, wherein the any additional devices are discovered in the order the any additional devices are traversed along the route to the device; and
wherein the steps of sending one or more requests and determining an indication of reliability for the respective network adapter occur after the identification of each of the any additional devices.

3. The method of claim 1 further comprising the steps of:
the computing device receiving an address for a sub-network within the network;
the computing device identifying a device on the sub-network based on the sub-network address, the device on the sub-network having a network adapter;
the computing device identifying any additional devices along a route to the device on the sub-network, each of the any additional devices along the route to the device on the sub-network having a respective network adapter;
the computing device sending one or more requests to the respective network adapter of each of the any additional devices along the route to the device on the sub-network and to the network adapter of the device on the sub-network; and
the computing device determining an indication of reliability for the respective network adapter of each of the any additional devices along the route to the device on the sub-network based on handling of the one or more requests by the respective network adapter and for the network adapter of the device on the sub-network based on handling of the one or more requests by the network adapter of the device on the sub-network.

4. The method of claim 1, wherein the indication of reliability is one of a list consisting of: a failure, a success, a percentage of failures, a percentage of successes, a bit error rate, and any combination of the preceding.

5. The method of claim 1, wherein the one or more requests are Internet Control Message Protocol (ICMP) echo requests and wherein each of the one or more ICMP echo request includes a data pattern.

6. The method of claim 5, wherein the handling on which the indication of reliability is based, comprises one of a failure to respond to the request, responding with an ICMP error message, and responding with an ICMP echo reply.

7. The method of claim 1, wherein the step of the computing device identifying any additional devices along the route to the device comprises the step of the computing device issuing a traceroute to an address of the device.

8. A computer program product comprising one or more computer-readable tangible storage devices and computer-readable program instructions which are stored on the one or more storage devices and when executed by one or more processors of the computing device of claim 1 perform the method of claim 1.

9. A computing device comprising one or more processors, one or more computer-readable memories, one or more computer-readable, tangible storage devices, an included network adapter, and program instructions which are stored on the one or more storage devices or embedded as control logic on the included network adapter for execution by the one or more processors via the one or more memories and when executed by the one or more processors perform the method of claim 1.

10. A computing device for testing network adapters, the computing device comprising:
one or more processors, one or more computer-readable memories, an included network adapter, and program instructions which are stored on at least one of the computer-readable memories or embedded as control logic on the included network adapter, for execution by the one or more processors via the one or more memories, the program instructions comprising:
instructions to receive a network address for a network;
instructions to identify a device on the network based on the network address, the device having a network adapter;
instructions to identify any additional devices along a route to the device, each of the any additional devices having a respective network adapter;
instructions to send one or more requests to the respective network adapter of each of the any additional devices and to the network adapter of the device; and
instructions to determine an indication of reliability for the respective network adapter of each of the any additional devices based on handling of the one or more requests by the respective network adapter and for the network adapter of the device based on handling of the one or more requests by the network adapter.

11. The computing device of claim 10, further comprising:
program instructions, stored on at least one of the one or more computer-readable memories or embedded as control logic on the included network adapter for execution by at least one of the one or more processors via at least one of the one or more memories, to:
receive an address for a sub-network within the network;
identify a device on the sub-network based on the sub-network address, the device on the sub-network having a network adapter;
identify any additional devices along a route to the device on the sub-network, each of the any additional devices along the route to the device on the sub-network having a respective network adapter;
send one or more requests to the respective network adapter of each of the any additional devices along the route to the device on the sub-network and to the network adapter of the device on the sub-network; and
determine an indication of reliability of the respective network adapter of each of the any additional devices along the route to the device on the sub-network based on handling of the one or more requests by the respective network adapter and for the network adapter of the device on the sub-network based on handling of the one or more requests by the network adapter of the device on the sub-network.

12. The computing device of claim 10, further comprising:
program instructions, stored on at least one of the one or more computer-readable memories or embedded as control logic on the included network adapter for execution by at least one of the one or more processors via at least one of the one or more memories, to log the indication of reliability on a tangible storage device.

13. The computing device of claim 10, wherein the indication of reliability is one of a list consisting of: a failure, a success, a percentage of failures, a percentage of successes, a bit error rate, and any combination of the preceding.

14. The computing device of claim 10, wherein the one or more requests are Internet Control Message Protocol (ICMP) echo requests and wherein each ICMP echo request includes a data pattern.

15. The computing device of claim 14, wherein the handling on which the indication of reliability is based, comprises one of a failure to respond to the request, responding with ICMP error message, and responding with an ICMP echo reply.

16. The computing device of claim 10, wherein the program instructions to identify any additional devices along the route to the device comprise instructions to issue a traceroute to an address of the device.

17. A network adapter, the network adapter comprising a chipset responsible for sending and receiving data to and from network devices and control logic for controlling the network adapter, the control logic comprising:
logic to simulate the receipt of a data stream comprising a data pattern by the network adapter;
logic to determine whether the network adapter processed the data pattern without any errors; and
logic to log results of the simulation.

18. The network adapter of claim 17, further comprising logic to run the control logic when the network adapter reaches a determined level of idleness.

19. The network adapter of 17, wherein the data stream comprising a data pattern comprises a worst-case data pattern.

20. The network adapter of 17, further comprising logic to run at predetermined intervals for as long as the network adapter is operational.
